(19) United States
(12) Patent Application Publication
(10) Pub. No.: US 2026/0169907 A1
(43) Pub. Date: Jun. 18, 2026

(54) DISTRIBUTED ON-CHIP KEY-VALUE STORE CIRCUIT ARCHITECTURE

(71) Applicant: Xilinx, Inc., San Jose, CA (US)

(72) Inventors: . Siddhartha, Singapore (SG); Haris Javaid, Singapore (SG); Chern Lin Justin Tan, Singapore (SG); Mario Baldi, Harpswell, ME (US)

(73) Assignee: Xilinx, Inc., San Jose, CA (US)

(21) Appl. No.: 18/986,690

(22) Filed: Dec. 18, 2024

(51) Int. Cl. G06F 12/02

(52) U.S. Cl. CPC G06F 12/0223

(57) ABSTRACT

An electronic system includes a key memory circuit capable of storing a plurality of keys and outputting an address for a key of the plurality of keys matched to a search key. The electronic system includes a memory manager circuit capable of tracking free memory addresses in the key memory circuit. The electronic system includes a state tracker circuit including a value memory circuit. The value memory circuit is capable of storing values of state information and is separate from the key memory circuit. The electronic system includes an insert-delete circuit capable of passing the address from the key memory circuit to the state tracker circuit, performing insert and delete operations on the key memory circuit, and providing free memory addresses of the key memory circuit to the memory manager circuit.

### TECHNICAL FIELD

This disclosure relates to integrated circuits (ICs) and, more particularly, to a distributed key-value store circuit architecture for ICs.

### BACKGROUND

A content addressable memory (CAM) refers to a type of memory circuit used to implement computer memory in high-speed computing applications. A CAM typically stores a data structure referred to as an associative array data structure that stores a plurality of key-value pairs. Within the associative array data structure, each possible key may be stored at most one time. This property of associative array data structures, as stored by CAMs, facilitates performance of operations by the CAM such as data lookups, data removals, and data insertions based on keys.

A key-value storage (KVS) system refers to a CAM-based circuit architecture capable of performing low-latency memory operations. KVS systems are often used to support execution of stateful applications with high data rates. A KVS system must be capable of operating at a high data rate without data loss. Further, the KVS system is expected to provide deterministic memory access latencies with bounded worst-case performance.

Existing KVS implementations are optimized to perform high-speed search performance particularly in the field of networking. The performance of memory operations other than search such as insert, update, and/or delete, however, is often sacrificed to implement the optimizations that facilitate high-speed search performance. As an illustrative example, existing KVS implementations are often able to perform billions of searches per second, while only being able to achieve insert, update, and/or delete operations at rates of approximately 100,000 per second. Further, in many existing KVS implementations, no search requests may be executed while an insert or update request is being serviced regardless of whether the requests are on different keys.

### SUMMARY

In one or more examples, an electronic system includes a key memory circuit capable of storing a plurality of keys and outputting an address for a key of the plurality of keys matched to a search key. The electronic system includes a memory manager circuit capable of tracking free memory addresses in the key memory circuit. The electronic system includes a state tracker circuit including a value memory circuit. The value memory circuit is capable of storing values of state information and is separate from the key memory circuit. The electronic system includes an insert-delete circuit capable of passing the address from the key memory circuit to the state tracker circuit, performing insert and delete operations on the key memory circuit, and providing free memory addresses of the key memory circuit to the memory manager circuit.

In one or more examples, a method includes storing a plurality of keys in a key memory circuit. The method includes, in response to receiving a search key, outputting, from the key memory circuit, an address for a key of the plurality of keys that matches the search key. The method includes passing the address from the key memory circuit to a plurality of state tracker circuits. Each state tracker circuit includes a value memory coupled to an arithmetic logic unit. The method includes, in each state tracker circuit of the plurality of state tracker circuits, implementing a selected operation by the arithmetic logic unit that generates state information for the search key.

This Summary section is provided merely to introduce certain concepts and not to identify any key or essential features of the claimed subject matter. Many other features and implementations of the disclosed technology will be apparent from the accompanying drawings and from the following detailed description.

### BRIEF DESCRIPTION OF THE DRAWINGS

The accompanying drawings show one or more implementations of the disclosed technology. The drawings, however, should not be construed to be limiting of the disclosed technology to only the examples shown. Various aspects and advantages will become apparent upon review of the following detailed description and upon reference to the drawings.

FIG. 1 illustrates a Key-Value-Store (KVS) circuit architecture in accordance with one or more implementations of the disclosed technology.

FIG. 2 illustrates certain operable features of a key memory circuit of the KVS circuit architecture of FIG. 1 in accordance with one or more implementations of the disclosed technology.

FIG. 3 illustrates an architecture for a state tracker circuit of the KVS circuit architecture of FIG. 1 in accordance with one or more implementations of the disclosed technology.

FIG. 4A illustrates an architecture of a key memory circuit of the KVS circuit architecture of FIG. 1 in accordance with one or more implementations of the disclosed technology.

FIG. 4B illustrates another architecture of a key memory circuit of the KVS circuit architecture of FIG. 1 in accordance with one or more implementations of the disclosed technology.

FIG. 5 illustrates an architecture of a priority encoder of the KVS circuit architecture of FIG. 1 in accordance with one or more implementations of the disclosed technology.

FIG. 6 illustrates a method of operation of the KVS circuit architecture of FIG. 1 in accordance with one or more implementations of the disclosed technology.

FIG. 7 illustrates a method of operation of the KVS circuit architecture of FIG. 1 in accordance with one or more implementations of the disclosed technology.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to integrated circuits (ICs) and, more particularly, to a distributed key-value store (KVS) circuit architecture for ICs. In accordance with the implementations described within this disclosure, a KVS circuit architecture is provided that is capable of performing both fast reads and writes. Implementations of the KVS circuit architecture may be implemented within an IC, e.g., may be implemented entirely “on-chip.”

In one or more examples, the KVS circuit architecture is capable of implementing back-to-back, pipelined reads and writes that support implementation of various operations such as search, insert, update, and delete at high data rates. Pipelining reads and writes supports the pipelining of operations such as search, insert, and update within the KVS circuit architecture. The delete operation, for example, typically occurs less frequently than operations such as search, insert, and/or update. Accordingly, in some examples, the delete operation within the KVS circuit architecture may be partially pipelined.

In one or more examples, the KVS circuit architecture is implemented as a distributed circuit architecture. The distributed circuit architecture separates storage and/or management of the keys from the corresponding values. The keys and the values may be stored in physically separate memories and/or memory banks. Keys may be stored in a key memory circuit while values may be stored in one or more value memories. The key memory circuit may be implemented as a binary, content-addressable memory (BCAM). Input/output (I/O) ports of the BCAM may include an address port or ports that enable the distributed implementation with respect to the value memories. The distributed architecture facilitates pipelined reads and writes of the BCAM.

The one or more value memories included in the KVS architecture may be implemented in corresponding state trackers. The state trackers are circuits that also include local or dedicated Arithmetic Logic Units (ALUs). Each ALU may be configured to implement particular functions on data stored in the respective value memories. The operation(s) performed by each ALU may be different or unique. Further, the ALUs may be implemented in close proximity with the respective value memories.

Accordingly, the disclosed technology may be used in any of a variety of applications/contexts including those that are stateful and require high-data rates. For purposes of illustration and not limitation, the disclosed technology may be used in hardware that supports high-speed networking, high-speed machine learning, and in network interface cards and/or controllers. For example, a KVS architecture as described herein may be used as a high-speed feature store to extract and track features for machine learning inference in networking among many other applications. The implementations described herein provide memory circuit architectures capable of performing low-latency operations and pipelined execution to perform required operations with a level of performance that avoids data loss. The disclosed technology is capable of performing operations with deterministic latencies and known worst-case bounds. Unlike many conventional KVS architectures, the KVS architectures described herein are capable of servicing a search request for a given key while performing an insert and/or update operation on a different key.

Further aspects of the disclosed technology are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

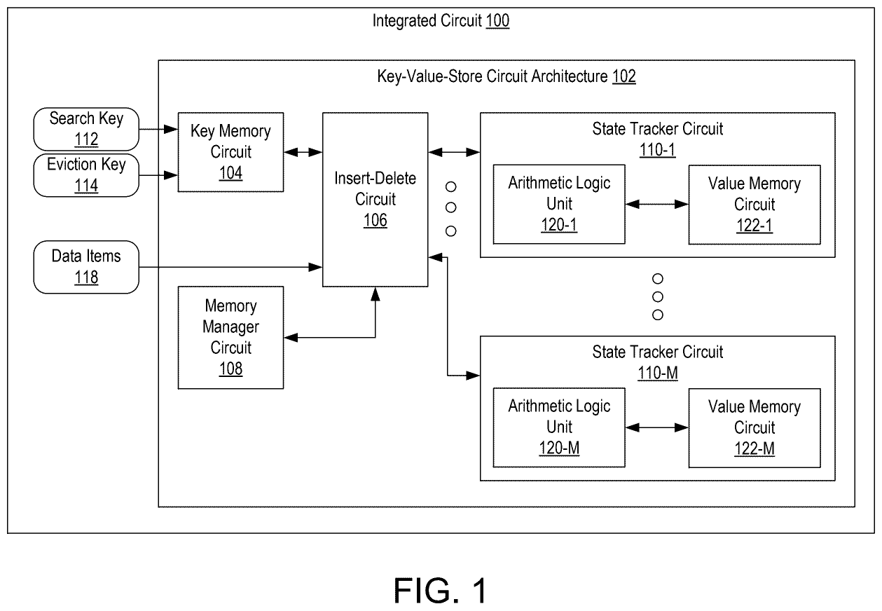

FIG. 1 illustrates a KVS circuit architecture (KVS architecture) 102 in accordance with one or more implementations of the disclosed technology. KVS architecture 102 is disposed, or implemented in, an IC 100. IC 100 may be implemented as any of a variety of different types of ICs. For example, IC 100 may be implemented as a System-on-Chip (SoC), an Application-Specific IC (ASIC), an adaptive IC (e.g., a programmable IC such as a Field Programmable Gate Array (FPGA)), a Graphics Processing Unit (GPU), or the like.

An adaptive IC is an IC that may be updated subsequent to deployment of the device into the field. An adaptive IC may be optimized, e.g., configured or reconfigured, for performing particular operations after deployment. The optimization may be performed repeatedly over time to meet different requirements or needs. A programmable IC includes any IC that includes at least some programmable circuitry. Examples of programmable circuitry include programmable logic and/or FPGA circuitry. A programmable IC is an example of an adaptive IC.

In the case where IC 100 is an adaptive IC or a programmable IC, one or more or all of the blocks of KVS architecture 102 are implemented using programmable circuitry. In the case where IC 100 is implemented as an ASIC or IC including hardened circuitry, one or more or all of the blocks of KVS architecture 102 may be implemented as hardened circuit blocks.

In the example of FIG. 1, KVS architecture 102 includes a key memory circuit 104, an insert-delete circuit 106, a memory manager circuit 108, and one or more state tracker circuits 110. In the example of FIG. 1, each of the blocks illustrated in the KVS architecture 102 represents a circuit or a combination of constituent circuits.

In the example, key memory circuit 104 is capable of storing a plurality of keys and outputting an address for a key of the plurality of keys matched to a search key. Key memory circuit 104 includes logic and a plurality of memory locations. Each memory location may be encoded into a corresponding and unique address. In one or more examples, key memory circuit 104 includes N different memory locations, where N is an integer value of two or more. Key memory circuit 104 is capable of storing data (e.g., content) such as a key in each of the N memory locations.

In one or more examples, key memory circuit 104 is implemented as a binary content addressable memory (BCAM). In the case of a BCAM, key memory circuit 104 stores only unique valid keys. That is, each valid key is stored at most one time in a single memory location.

In the example, key memory circuit 104 is capable of receiving various input data items such as a search key 112 and/or an eviction key 114. Key memory circuit 104 is capable of searching the N memory locations for a key stored therein that matches search key 112. Key memory circuit 104 is also capable of searching the N memory locations for a key stored therein that matches eviction key 114. In response to matching either search key 112 or eviction key 114 to a key stored in one of the N memory locations, key memory circuit 104 is capable of outputting an address of the memory location storing the matched key. Key memory circuit 104 is capable of outputting the address of the matched key to insert-delete circuit 106.

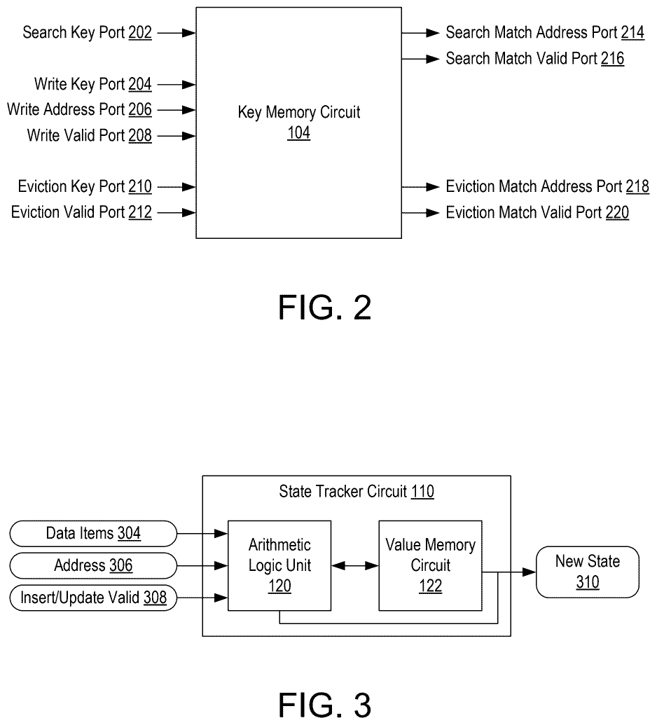

In one or more implementations, key memory circuit 104 has a plurality of input/output (I/O) ports. The I/O ports include one or more address ports illustrated in greater detail in connection with FIG. 2. The inclusion of the address ports facilitates the distributed architecture of KVS architecture 102 with value memory circuits being separate and distinct from key memory circuit 104.

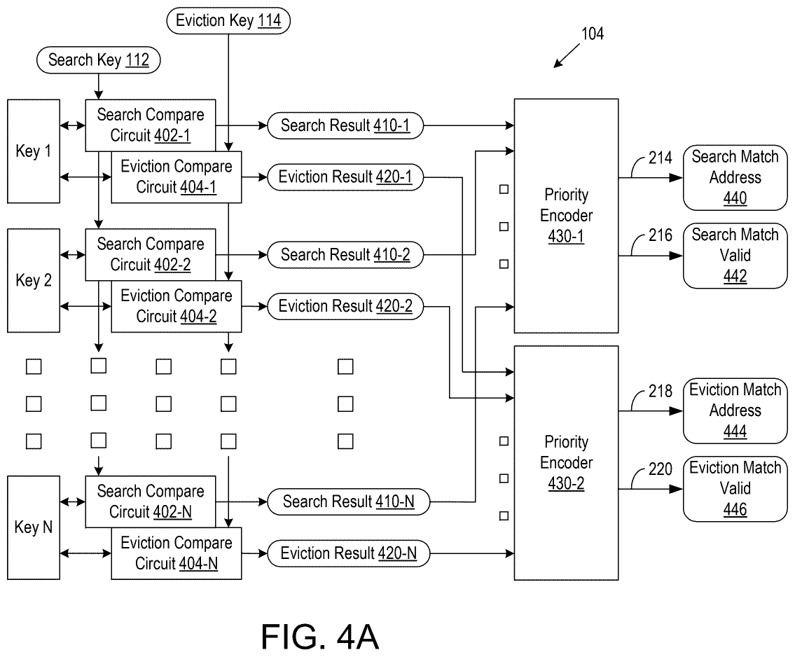

In one or more implementations, insert-delete circuit 106 is capable of receiving addresses from KVS architecture 102 and passing the addresses to state tracker circuits 110. Insert-delete circuit 106 is also capable of initiating and/or facilitating insert and delete operations on key memory circuit 104. In the example, KVS architecture 102 includes M different state tracker circuits 110 (e.g., 110-1 through 110-M), where M is an integer value of one or more. In the example, M and N may be different values. Each state tracker circuit 110 includes an Arithmetic Logic Unit (ALU) 120 and a value memory circuit 122. Insert-delete circuit 106 is capable of passing addresses to each state tracker circuit 110. Further details relating to the state tracker circuits 110 are described in connection with FIG. 3.

As illustrated, insert-delete circuit 106 is also capable of receiving data items 118. Data items 118 may include any of a variety of different information that is associated with search key 112. For example, data items 118 may specify a timestamp of the search key, a number of bytes of a transaction corresponding to the search key, or the like. In general, data items 118 specify data, e.g., values, that are used by different ones of the state tracker circuits 110 for performing state tracking functions relating to a given key. The state tracking operations are examples of update operations performed by KVS architecture 102. Insert-delete circuit 106 is capable of distributing data items 118 to the different ones of state tracker circuits 110. As each state tracker circuit 110 may be configured to perform a particular state tracking function, different ones of state tracker circuits 110 may require different ones of data items 118. Insert-delete circuit 106 is capable of distributing data items 118 to the appropriate state tracker circuits 110.

In the case where IC 100 is implemented as a programmable IC or an adaptive IC, state tracker circuits 110 may be coupled to insert-delete circuit 106 through programmable circuitry based on user specified requirements. The requirements may specify information such as the number of state trackers to implement, the function to be performed by each state tracker, the particular data items 118 to be provided to each state tracker circuit 110, and the like. The user-specified requirements may be implemented at compile time of the programmable circuitry. Further, it should be appreciated that such circuitry, including a number of state tracker circuits 110 may be dynamically updated or changed through dynamic reconfiguration of the programmable circuitry.

In the case where IC 100 is not programmable or adaptable, the number of state tracker circuits 110 may be fixed. In addition, the state tracker circuits 110 may be coupled to insert-delete circuit 106 through hardened circuitry such as a switch, multiplexing circuitry, or crossbar circuitry. Such circuitry may be pre-configured to route different ones of the data items 118 to different ones of state tracker circuits 110. In one or more examples, in an ASIC implementation, a configurable crossbar may be used and positioned at inputs of state tracker circuits 110 so that all arriving values at runtime can drive any of the inputs of the different state tracker circuits 110 depending on the configuration.

In the case of a configurable crossbar, a programmer circuit may configure any programmable elements and the configurable crossbar at the start of operation of KVS architecture 102. In the example of FIG. 1, in an ASIC implementation, the functionality of ALUs 120 may be fixed. For example, in the networking domain, the headers of arriving packets do not determine the type of ALU operations to perform, but instead dictate the packet-processing handling.

Memory manager circuit 108 is a dedicated memory manager for KVS architecture 102. Rather than being implemented in software by another processor such as a host system, memory manager circuit 108 is implemented in hardware on-chip with, or as part of, KVS architecture 102 to provide improved performance and less latency than a software implementation. Memory manager circuit 108 is capable of tracking free memory addresses in the key memory circuit 104. A free memory address is an address of a memory location of key memory circuit 104 that is not storing a valid key. That is, the content in the memory location specified by a free memory address is invalid and may be overwritten. A key that has been deleted is an example of an invalid key. In one or more examples, memory manager circuit 108 is implemented using a circular buffer with read and write pointers.

In the example of FIG. 1, for any search key 112 received that is not found to match an existing entry in key memory circuit 104, for example, insert-delete circuit 106 is capable of obtaining a free memory address from a list of free memory addresses maintained by memory manager circuit 108 and storing the search key in the memory location of key memory circuit 104 specified by the obtained free memory address. Insert-delete circuit 106 may also pass the address to state tracker circuits 110 along with any other data items 118 that may have been received in the request specifying search key 112.

In the example of FIG. 1, for any delete key 114 received that matches an existing key stored in memory circuit 104, for example, key memory circuit 104 outputs the address of the matched key to insert-delete circuit 106. Further operations performed by key memory circuit 104 for a deletion operation are described herein in greater detail below. Insert-delete circuit 106 is capable of receiving the address from key memory circuit 104 and notifying memory manager circuit 108 that the address is now a free memory location. Memory manager circuit 108 adds the address to the list of free memory addresses for later use.

In the example of FIG. 1, key memory circuit 104, insert-delete circuit 106, and memory manager circuit 108 are capable of performing search, insert, and delete operations. Key memory circuit 104, insert-delete circuit 106, memory manager circuit 108, and state tracker circuits 110 are capable of implementing update operations. Further implementation details relating to search, insert, delete, and update operations are provided hereinbelow.

FIG. 2 illustrates certain operable features of key memory circuit 104 in accordance with one or more implementations of the disclosed technology. In the example, key memory circuit 104 is implemented as a BCAM. The BCAM has a depth of 2 to the power of the address width in bits. The width of the BCAM is the width of a key (the key width) to be stored in bits plus one additional bit. The additional bit is used to indicate whether content stored in a given memory location of the BCAM is a valid key.

In the example, key memory circuit 104 includes the following input ports: search key port 202, a write key port 204, a write address port 206, a write valid port 208, an eviction key port 210, and an evict valid port 212. Key memory circuit 104 further includes the following output ports: a search match address port 214, a search match valid port 216, an eviction match address port 218, and an eviction match valid port 220.

In the example, search key port 202, eviction key port 210, and eviction valid port 212 are coupled to circuitry external to KVS architecture 102. Search key port 202 is capable of receiving search keys such as search key 112. Eviction key port 210 is capable of receiving eviction keys such as eviction key 114. Eviction key valid port 212 is capable of receiving a signal indicating whether the eviction key specified on eviction key port 210 is valid. For example, KVS architecture 102 may be coupled to other interface circuitry capable of receiving requests. The requests may specify a search key or an eviction key along with one or more other data items (e.g., data items 118). The interface circuitry may provide the data items to the respective ports of key memory circuit 104.

Write key port 204, write address port 206, and write valid port 208 are coupled to output ports of insert-delete circuit 106. Search match address port 214 and search match valid port 216 may be coupled to input ports of insert-delete circuit 106. Evict match address port 218 and valid port 220 may be coupled to input ports of memory manager circuit 108. As discussed, the output ports of key memory circuit 104 may be coupled to insert-delete circuit 106 via programmable circuitry or a crossbar depending on the particular implementation.

FIG. 3 illustrates an architecture for state tracker circuit 110 in accordance with one or more implementations of the disclosed technology. The example of FIG. 3 may be used to implement each state tracker circuit 110. As illustrated, state tracker circuit 110 includes an ALU 120 coupled to value memory circuit 122. ALU 120 is configured to perform particular operations to generate state data. The ALU of each state tracker circuit 110 may be configured to generate different state data.

In the case where IC 100 is implemented as a programmable IC or an adaptive IC, each state tracker circuit 110 may be implemented using programmable circuitry based on user specified requirements. The requirements may specify information such as the number of state trackers to implement, the function to be performed by each state tracker, and the like. In the case where IC 100 is not programmable or adaptable, each state tracker circuit may be pre-configured to perform a particular operation to generate state data. Each ALU 120 may be configured to generate a different type of state data. In this regard, each ALU 120 is capable of implementing a compute function that may be invoked for each update operation in KVS architecture 102.

In the example of FIG. 3, each state tracker circuit 110 receives data 304, an address 306, and an update/insert valid 308 over separate input ports. Data 304 includes any required data items for the particular operation being performed by state tracker circuit 110. Address 306 specifies the address output from insert-delete circuit 106. Update/insert valid 308 specifies whether the input operation is an insert request or an update request. Update/insert valid 308, for example, is capable of informing ALU 120 whether the information being provided corresponds to a new key (e.g., an insert operation) or an existing key (e.g., an update operation) for purposes of tracking multiple iterations of computation by ALU 120 in cases where the behavior of the operation differs in a first iteration compared to subsequent iterations.

In one or more implementations, each ALU 120 may be statically configured to implement a particular compute function that may be performed in response to each insert operation and/or update operation on the states (e.g., values stored in value memory circuits 122). The following is a list of example operations that each ALU 120 may be configured to perform. Appreciably, each ALU 120 of a different state tracker circuit 110 may implement a different one of the compute functions.

Within the examples described below, the term “val” represents the current value stored in a memory location of value memory circuit 110; the term “imm” represents the immediate value supplied in the operation (e.g., data item(s) 304 as obtained or extracted from data items 118); and the term “addr” represents the address passed to the state tracker circuits 110 by insert-delete circuit 106 as address 306. Thus, the terms “imm” and data item(s) 304 may be used interchangeably in the operation descriptions below. Similarly, the terms “addr” and address 306 may be used interchangeably in the operation descriptions below.

In the examples below, values written or stored in the value memory circuit 122 are stored at the memory location therein specified by addr. Similarly, any values read from the value memory circuit 122 are read from the memory location therein specified by addr.

accum: The accum operation increments val by the imm value and stores the result back in the memory location of value memory circuit 110. Upon insert as indicated by insert/update valid 308, imm is simply stored as val at address 306 and output as new state 310. The accum operation may be configured as a signed or an unsigned integer operation. Upon update as indicated by insert/update valid 308, the accum operation reads the value from address 306, adds the value to data item 304, writes the result back to value memory circuit 122 at address 306, and outputs the result as new state 310. A special case of accum is when imm is programmed to a constant 1, which provides a count operation.

delta_init: The delta_init operation subtracts val from imm and outputs the result to other circuitry (e.g., in IC 100) as new state 310. val is only stored once at initialization during which the output sent to the next stage is 0. The delta_init operation may be used for calculating durations where val is the timestamp of the first observed occurrence, and imm are timestamps of subsequent observations in the future. The delta_init operation is an unsigned integer operation.

In this example, the ALU writes (e.g., stores) a value such as a timestamp (e.g., data item 304) of a first packet in a flow in the value memory circuit 122 in a first iteration (e.g., upon insert) as indicated by insert/update valid 308. The value output as new state 310 is 0. For timestamps of subsequent packets of the flow, e.g., updates as indicated by insert/update valid 308, the timestamps, e.g., data item 304, are not stored but rather are used to calculate a snapshot of duration. In this case, the ALU reads the timestamp from address 306 of value memory circuit 122 and subtracts data item 304 (e.g., timestamp) from the timestamp read from value memory circuit 122 with the result being output as new state 310. In this respect, the delta_init operation writes or stores a value (e.g., a timestamp) in a first iteration as indicated by insert/update valid 308 and reads values from the value memory circuit 122 in subsequent invocations as indicated by insert/update valid 308.

delta: The delta operation subtracts val from imm and outputs the result to other circuitry as new state 310. In the delta operation, val is then updated to store the imm value which will be used for the next computation. The delta operation may be a signed or an unsigned integer operation depending on the use-case. For example, in a high-speed networking context, the delta operation may be used to compute packet inter-arrival times (IATs). For the delta operation, upon insert, as specified by insert/update valid 308, data 304 is written to address 306 of value memory circuit 122 by ALU 120. Upon insert, a value of 0 is output as new state 310. Upon update, as indicated by insert/update valid 308, ALU 120 reads from address 306 of value memory circuit 122, subtracts the read value from the arriving data 304, and returns the result as new state 310. Upon updates and subsequent to the read described, ALU 120 then writes data 304 to address 306 of value memory circuit 122 for use in a next iteration/invocation.

max: The max operation computes max(val, imm) and writes the result back into the value memory circuit 110. Upon initialization, imm is stored as val. The max operation may be configured to be a signed or an unsigned integer operation. The max operation may be fused with the delta operation above to produce the following function: delta_max=max(max_val, delta(val, imm)), where max_val is an additional state for storing the maximum value. This fused operation may be used to track the maximum packet inter-arrival time (IAT).

min: The min operation computes min(val, imm) and writes the result back to the value memory circuit 110. Upon initialization, imm is stored as val. The min operation can be configured as a signed or an unsigned integer operation. The min operation may be fused with the delta operation above to produce the following function: delta_min=min(min_val, delta(val, imm)), where min_val is an additional state for storing the minimum value. This fused operation may be used to track minimum packet IAT.

In the case of both the min operation and the max operation, upon insert as indicated by insert/update valid 308, data 304 is written by ALU 120 into value memory circuit 122 at address 306. Further, ALU 120 outputs data 304 as new state 310. Upon update as indicated by insert/update valid 308, ALU 120 reads data from value memory circuit 122 at address 306 and compares the read value with the value specified by data items 304. ALU 120 selects the minimum or maximum value depending on the particular operation being performed, stores the selected value at address 306 of value memory circuit 122, and outputs the selected value as new state 310.

count_eq: The count_eq operation is configured with a constant (const) in the compute logic. val is the occurrence count and is incremented by 1 every time the condition imm==const evaluates to true. The count_eq operation may be configured to be a signed or an unsigned integer operation. The count value (i.e., val) is stored as an unsigned integer.

burst_count: The burst_count operation is capable of measuring the number of back-to-back accesses to the same key. Since the physical address into the value memory circuit 110 is logically equivalent to the unique key being accessed, the burst_count operation need only store the last accessed address as val. Then, an input address, addr, is compared to the stored val. Accordingly, if addr==val, a burst-count counter is incremented by 1, or otherwise reset to 1. val is then overwritten by addr and the computed burst-count counter value is produced as the output. The output is an unsigned integer.

In the case of the burst_count operation, only one memory location is needed in the value memory circuit since the stateful value is shared globally across all elements in KVS architecture 102. In illustration, consider the following scenario involving arriving packets for two flows A and B. In the example, flow A has received 2 packets and flow B has received 3 packets in the following order from oldest to newest: ABBBA. The burst_count operation would output the following on each packet arrival (where packets in brackets [ ] indicate past or prior received packets of the flows).

A: isolated occurrence of flow A, burst_count=1.

[A]B: isolated occurrence of flow B, burst_count=1.

[AB]B: back-to-back occurrence of flow B, burst_count=2.

[ABB]B: back-to-back occurrence of flow B, burst_count=3.

[ABBB]A: isolated occurrence of flow A, burst_count=1.

In the example, if another packet from flow B arrives next, the outcome would be [ABBBA]B: burst_count=1.

In the examples described herein, the datatypes used for each example operation may be different. For example, the datatypes may include, but are not limited to, signed/unsigned integer, fixed or floating point, etc. It should be appreciated that fewer or more operations may be included for ALUs 120. Further, different combinations of operations may be fused together. In programmable IC/adaptive IC implementations, all integer bit widths can be statically configured and optimized to any custom values. In the case of an ASIC implementation, a general processing element can be developed that provides configuration registers to configure the ALU operation required for the operations described above. Further, in the ALU implementation, configuration registers may be included to configure the bit widths (e.g., 8 b, 16 b, 32 b, 64 b, etc.) of the operations. For example, the configuration registers may specify a 64 b unsigned subtraction for the duration calculation using 64 b time stamps in the delta_init operation.

In one or more implementations, to provide fast operation, only integer operations are supported. In other implementations, other types of operations (e.g., non-integer operations) may be supported at the cost of reduced performance.

Each state tracker circuit 110 may be configured to perform one of the particular operations described herein. As such, depending on the particular operation being performed by a given state tracker circuit 110, ALU 120 in each state tracker circuit 110 is capable of performing operations that may include, but are not limited to, writing a value to the enumerated memory location specified by addr in the connected or corresponding value memory circuit 122 (e.g., where the value is one passed to ALU 120 such that ALU 120 performs a pass-through writing operation), reading a value from the enumerated memory location specified by addr in the connected or corresponding value memory circuit 122 (e.g., where the value read may be used in performing the operation), and/or writing a value to the enumerated memory location specified by addr in the connected or corresponding value memory circuit 122 (e.g., where the value written is one calculated or generated by ALU 120 in executing the operation). Each state tracker circuit 110 is further capable of outputting data as a new state 310 to one or more other circuits and/or systems of IC 100. It should be appreciated that whether values are read, written, updated, and/or output depends on the particular operation being performed by the ALU and/or the particular iteration or invocation of such operation (e.g., whether the current invocation is an insert or an update).

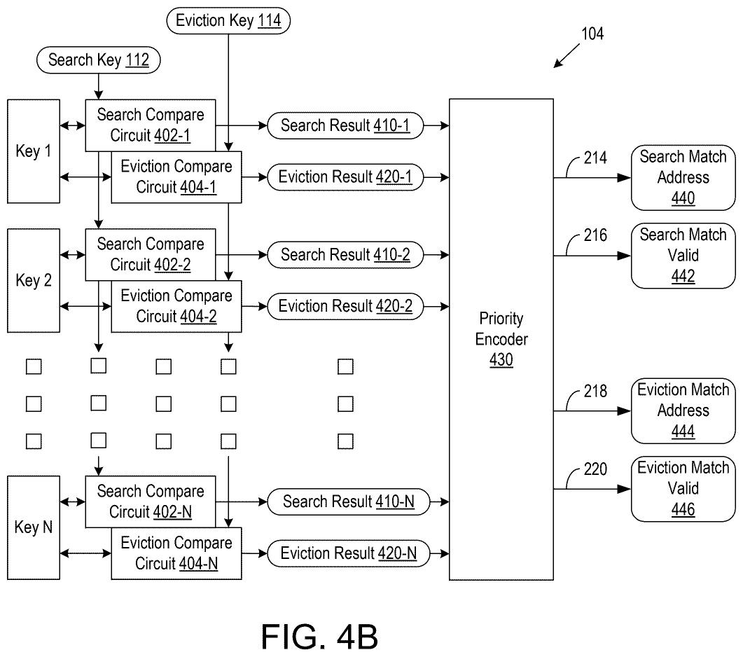

FIG. 4A illustrates an architecture of key memory circuit 104 in accordance with one or more implementations of the disclosed technology. The architecture of FIG. 4A includes a pipelined search circuit architecture (e.g., fully pipelined) and a pipelined eviction circuit architecture (e.g., at least partially pipelined). Further, a BCAM implementation of key memory circuit 104 is shown. As illustrated, key memory circuit 104 is implemented as a register-based architecture. In the example, the search and/or eviction keys may be fully unrolled and pipelined for back-to-back search and/or delete operations. In the example, the initiation interval (II) may be one such that a new search and/or delete may be introduced on each clock cycle. The pipelining illustrated is facilitated, at least in part, by the separate storage of values from keys using the distributed KVS architecture described herein.

In the example, keys 1 through N are stored in different memory locations of key memory circuit 104. As noted, the memory locations may be implemented in or as a BCAM. Search key 112 may be provided to each search compare circuit 402-1 through 402-N (e.g., logic circuits). Eviction key 114 may be provided to each eviction compare circuit 404-1 through 404-N (e.g., logic circuits).

In the example, each search compare circuit 402 is capable of performing a comparison operation to determine whether search key 112 matches the content stored in the corresponding memory location on each clock cycle. Accordingly, in the case where key memory circuit 104 includes N memory locations, key memory circuit 104 is capable of performing N comparisons in parallel each clock cycle. In one or more examples, on each clock cycle, each instance of search compare circuit 402 is capable of comparing search key 112 with the contents of the corresponding memory location and outputting a 1-bit result as search result 410 (e.g., 410-1 through 410-N). Each search result 410 may be a Boolean flag that indicates whether a match was found by the comparison performed by the corresponding search compare circuit 402. It should be appreciated that for any memory location that includes a validity bit indicating an invalid state for the memory location, the corresponding search compare circuit 402 will return a result indicating no match found.

In the example of FIG. 4A, key memory circuit 104 includes multiple instances of a priority encoder 430 shown as priority encoder 430-1 and priority encoder 430-2. In the example of FIG. 4A, search results 410-1 through 410-N, taken collectively, form a bit vector that is provided to priority encoder 430-1. The bit vector is a one-hot encoded bit vector. As each key (e.g., each valid key) is stored in key memory circuit 104 at most one time, at most one bit of the bit vector will indicate a match was found. Priority encoder 430-1 is capable of encoding the received bit vector to generate an address. In the case of search key 112, priority encoder 430-1 is capable of generating from the bit vector formed of search results 410 search match address 440 and outputting search match address 440 via search match address port 214. Priority encoder 430-1 is also capable of outputting search match valid 442 via search match valid port 216 indicating whether search match address 440 is valid.

In the example of FIG. 4A, each eviction compare circuit 404 is capable of performing a comparison operation to determine whether eviction key 114 matches the content stored in the corresponding memory location on each clock cycle. Accordingly, in the case where key memory circuit 104 includes N memory locations, key memory circuit 104 is capable of performing N comparisons in parallel each clock cycle. In one or more examples, on each clock cycle, each instance of eviction compare circuit 404 is capable of comparing eviction key 114 with the contents of the corresponding memory location and outputting a 1-bit result as eviction result 420 (e.g., 420-1 through 420-N). Each eviction result 420 may be a Boolean flag that indicates whether a match was found by the comparison performed by the corresponding eviction compare circuit 404. It should be appreciated that for any memory location that includes a validity bit indicating an invalid state for the memory location, the corresponding eviction compare circuit 404 will return a result indicating no match found.

Eviction results 420-1 through 420-N, taken collectively, form a bit vector that is provided to priority encoder 430-2. The bit vector may be a one-hot encoded bit vector. Priority encoder 430-2 is capable of encoding the received bit vector to generate an address. In the case of eviction key 114, priority encoder 430-2 is capable of generating from the bit vector formed of eviction results 420 eviction match address 444 and outputting eviction match address 444 via eviction match address port 218. Priority encoder 430-2 is also capable of outputting eviction match valid 446 via eviction match valid port 220 indicating whether eviction match address 444 is valid.

As discussed, each key stored in the BCAM is concatenated with a validity bit that indicates whether the stored key is currently active (e.g., whether the content stored in the memory location is a valid key). The validity bit provides a less memory intensive mechanism for performing delete operations. In one or more examples, in response to an instance of eviction compare circuit 404 finding a match for eviction key 114 that has a validity bit indicating a valid state and the address of the matched key being generated by priority encoder 430-2, insert-delete circuit 106 receives eviction match address 444 and sets the validity bit of the memory location of key memory circuit 104 specified by eviction match address 444 to indicate an invalid state. An invalid state indicates that the key stored in the memory location is no longer valid. This operation is equivalent to deleting the key. It should be appreciated that in setting the validity bit to indicate an invalid state, no interaction with the state tracker circuits 110 (e.g., with either the ALUs 120 or the value memory circuits 122 therein) is required. That is, the delete operation may be performed without involvement of the state tracker circuits 110. In this regard, a delete operation is said to operate only on key memory circuit 104.

In the example of FIG. 4A, as the search and eviction circuitry may be implemented separately, e.g., have separate and independent pipelines, situations may arise where a search request and an eviction request are received simultaneously (e.g., on a same clock cycle) that specify a same key (e.g., search key 112 is the same as eviction key 114 and both are received on the same clock cycle). Accordingly, KVS architecture 102 may include a configuration register capable of storing a user-specified setting that defines behavior of KVS architecture 102 in this situation. In one or more examples, the user-specified setting may specify which operation takes precedence over the other and is performed first and which operation is delayed to the next clock cycle or rejected. A similar situation may occur for update and delete operations received on the same clock cycle specifying the same key. The configuration register may be programmed with a user-specified setting indicating which operation is to be performed first and which is to be pushed to the next clock cycle or rejected.

FIG. 4B illustrates another architecture of key memory circuit 104 in accordance with one or more implementations of the disclosed technology. The example of FIG. 4B is substantially similar to the example of FIG. 4A with the exception that a single instance of priority encoder 430 is used. In the example, each search compare circuit 402 and each eviction compare circuit 404 is coupled to priority encoder 430. As such, priority encoder 430 generates addresses from bit vectors specifying matched search keys and/or matched eviction keys.

In the example of FIG. 4B, because occurrences of evictions often occur significantly less than searches, e.g., an order of magnitude less, search compare circuits 402 and eviction compare circuits 404 are able to share a same instance of priority encoder 430. To facilitate sharing, buffering and multiplexing circuitry may be added that couples search compare circuits 402 and eviction compare circuits 404 with priority encoder 430. The example of FIG. 4A does not require the additional circuitry to implement buffering and/or multiplexing functions, but may require additional area to accommodate the additional instance of priority encoder 430.

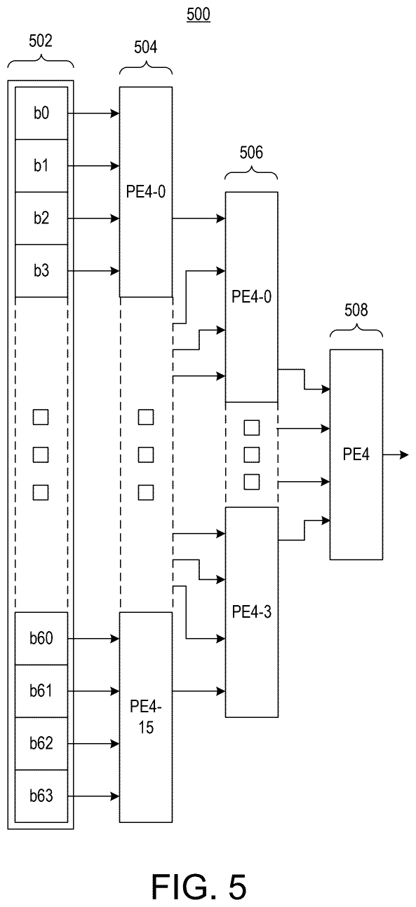

FIG. 5 illustrates an architecture 500 of priority encoder 430 in accordance with one or more implementations of the disclosed technology. In general, priority encoder 430 is a circuit that is capable of receiving multiple input signals, e.g., the Boolean flags of a bit vector 502 indicating comparison results, and outputting a binary representation of the highest priority input that is active. In the example, only one input will be active (e.g., bit vector 502 is one-hot encoded).

In general, priority encoder 430 is capable of converting the bit vector into the address of the memory location for which a match was detected by the relevant comparison circuitry (e.g., the particular instance of search compare circuit 402 or the particular instance of evict compare circuit 404 as the case may be). In the example, priority encoder 430 may be implemented in a fully pipelined manner.

In the example of FIG. 5, priority encoder 430 may be implemented using a tree-like structure having a plurality of stages illustrated as stages 504, 506, and 508. In the example, the encoding computation is broken out into log₄(N) stages resulting in 3 stages presuming a 64-bit vector. The number of stages is not intended as a limitation. The number of stages used may be selected to balance latency in generating the address with respect to the size of the bit vector.

Stage 504 receives bit vector 502. In the example, the bit vector includes bits illustrated as b0, b1, through b63 (e.g., a 64-bit vector). It should be appreciated that the particular size of the bit vector will depend on the value of N in key memory circuit 104. The value of each bit indicates whether a match was found in the memory location corresponding to the bit. At most one bit is active (e.g., one bit indicates a match). Stage 504 may include processing elements (PEs) 0 through 15, where each processing element receives 4 inputs (e.g., 4 bits from bit vector 502). Stage 506 includes PEs 0 through 3 where each PE in stage 506 receives 4 inputs, where each input to stage 506 is an output from a PE in stage 504. Stage 508 includes a single PE that receives 4 inputs, where each input to the PE of stage 508 is an output generated by a PE of stage 506. The example of FIG. 5 has a latency of log₄(64) or 3 clock cycles from end to end.

In other examples, processing elements that are capable of receiving different numbers of inputs may be used such as 8 where larger numbers in powers of 2 provide lower latency for address generation. It should be appreciated that priority encoder 430 may process search results 410 or eviction results 420 for a given clock cycle. As discussed, priority encoder 430 may be implemented as a shared circuit (e.g., a single instance) or duplicated (e.g., multiple instances). Whether priority encoder 430 is shared or not may depend on area and/or performance requirements of the design. As discussed, in the case of a single instance of priority encoder 430, additional circuitry may be needed. Such additional circuitry may include buffers capable of temporarily storing eviction bit vectors in cases where priority encoder 430 is busy processing a concurrent search bit vector. The circuitry further may include a multiplexer capable of switching between search and eviction bit vectors as input to priority encoder 430.

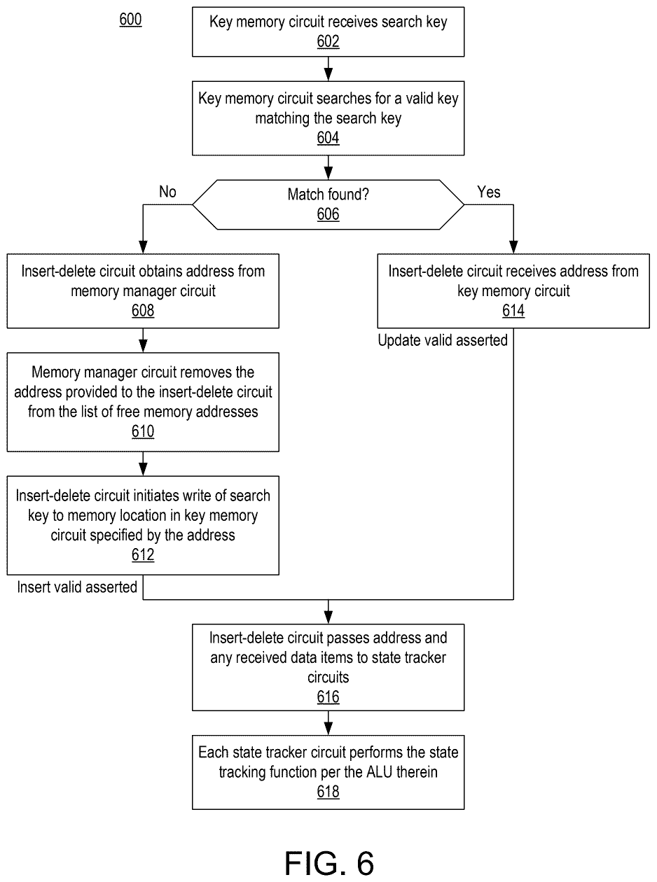

FIG. 6 illustrates a method 600 of operation for KVS architecture 102 of FIG. 1 in accordance with one or more implementations of the disclosed technology. Method 600 illustrates an example of search key processing as performed by KVS architecture 102. Method 600 may begin in a state where key memory circuit 104 is storing a plurality of keys and KVS architecture 102 has received a request specifying search key 112.

In block 602, key memory circuit 104 is capable of receiving search key 112. In block 604, in response to receiving search key 112, key memory circuit 104 is capable of searching for a valid key that matches search key 112. As discussed, each search compare circuit 402 is capable of comparing search key 112 with contents of a corresponding memory location and outputting a search result 410. The search results 410 collectively form bit vector 502 which is provided to priority encoder 430.

Priority encoder 430 outputs search match address 440 and search match valid 442 to insert-delete circuit 106. In the example, a valid state of search match valid 442 indicates that search match address 440 is valid, e.g., that a match to search key 112 was found. An invalid state of search match valid 442 indicates that search match address 440 is invalid and that the search did not find a key matching search key 112 in key memory circuit 104.

In block 606, in response to finding a match (e.g., search valid match 442 indicating a valid state), method 600 continues to block 614. In response to no match being found (e.g., search valid match 442 indicating an invalid state), method 600 continues to block 608.

Continuing with block 608, an insert operation is started in which search key 112 is added to key memory circuit 104. In block 608, in the case where no match was found, insert-delete circuit 106 is capable of requesting an address from memory manager circuit 108. Memory manager circuit 108 maintains a list of free memory addresses and, in response to a request from insert-delete circuit 106 provides a memory address from the list to insert-delete circuit 106. Accordingly, insert-delete circuit 106 obtains an address from memory manager circuit 108. In block 610, memory manager circuit 108 is capable of removing the address provided to insert-delete circuit 106 from the list of free memory addresses.

In block 612, in response to receiving the address from memory manager circuit 108, insert-delete circuit 106 initiates a write of search key 112 to the memory location in key memory circuit 104 specified by the address received from memory manager circuit 108. For example, insert-delete circuit 106 initiates the write by providing the key to write key port 204, providing the address to write address port 206, and providing a signal indicating valid on write valid port 208.

Continuing with block 614, an updated operation is started in which search key 112 was found to match an entry in key memory circuit 104. Continuing with block 614, in the case where a match was found, insert-delete circuit 106 receives the address as output from key memory circuit 104. The address output from key memory circuit 104 is the address of the memory location within key memory circuit 104 that stores a valid key matching search key 112. In this case, for example, the valid state of search match valid 442 indicates that search match address 440 is invalid.

Proceeding to block 616, insert-delete circuit 106 is capable of passing date items 304 (e.g., selected ones of data items 118), address 304, and insert/update valid 306 to state tracker circuits 110. In the case where block 616 is reached from block 612, the address passed to state tracker circuits 110 is the address obtained from memory manager circuit 108 and insert/update valid 306 indicates an insert operation (e.g., insert valid asserted). In the case where block 616 is reached from block 614, the address passed to state tracker circuits 110 is the address obtained from key memory circuit 104 and insert/update valid 306 indicates an update operation (e.g., update valid asserted).

As noted, any date items 118 that may have been received in connection with search key 112 may be provided to the appropriate state tracker circuits 110 based on the particular operation performed by each state tracker circuit 110 as data items 304. For example, search key 112 may have been specified within a request that included one or more data items needed to perform the state tracking functions performed by respective ones of state tracker circuits 110. Insert-delete circuit 106 is configured to pass the particular ones of data items 118 needed by each state tracker circuit 110 to the appropriate state tracker circuits as data items 304.

In one or more implementations, insert-delete circuit 106 is capable of formatting the respective data items as arguments to be used in performing the functions described in connection with FIG. 3. As an illustrative example, if state tracker circuit 110-1 is configured to implement the accum operation, insert-delete circuit 106 will receive a value included in data items 118 that may be provided as imm to state tracker circuit 110-1. The address is also provided to state tracker circuit 110-1. If state tracker circuit 110-1 is configured to implement a count operation, insert-delete circuit 106 may provide a value of “1” as imm. The address may be provided on a separate and dedicated input port. Simultaneously or concurrently, if state tracker circuit 110-2 is configured to implement the max operation, insert-delete circuit 106 will receive a value included in data items 118 that may be provided to state tracker circuit 110-2 as imm. The address is also provided to state tracker circuit 110-2, e.g., on a separate and dedicated input port. As noted, in a first iteration (e.g., at initialization in arriving at block 616 from block 612), imm is stored as val. It should be appreciated that data items 118 may include a plurality of different data items or values such that the particular value provided to state tracker circuit 110-1 as imm may be different from the value provided to state tracker circuit 110-2 as imm, and so forth.

Each different state tracker circuit 110 may be configured to perform a different or particular operation and/or fused operation as the case may be. The operation is performed as part of an overall update operation implemented by KVS architecture 102 for search key 112. The value memory circuit 122 of each state tracker circuit 110 includes sufficient memory locations for storing state information for each valid key. Each value memory circuit 122 will use the same addressing scheme. Accordingly, while the state information for a given key in each state tracker circuit may be different, the state information for that key is stored at the same address in each different value memory circuit 122.

Accordingly, in block 618, each state tracker circuit performs the state tracking function per the ALU therein. That is, each ALU 120 performs the particular function the ALU has been configured to perform in response to receiving the address and any other necessary data items (e.g., the respective imms). Method 600 may continue to iterate as further search keys are received.

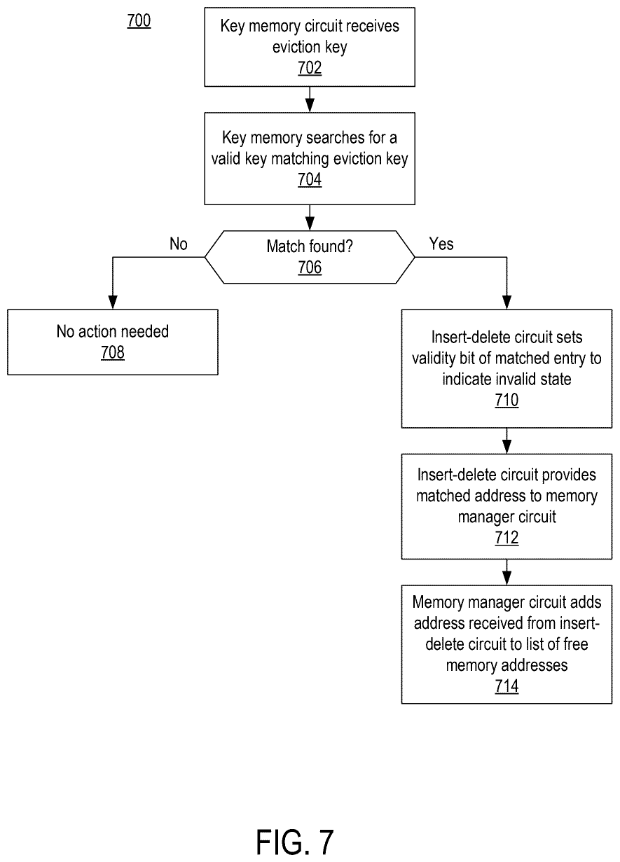

FIG. 7 illustrates a method 700 of operation for the KVS architecture 102 of FIG. 1 in accordance with one or more implementations of the disclosed technology. Method 700 illustrates an example of eviction key processing as performed by KVS architecture 102. Method 700 may begin in a state where a request specifying eviction key 114 has been received.

In block 702, key memory circuit 104 is capable of receiving eviction key 114. In block 704, in response to receiving eviction key 114, key memory circuit 104 is capable of searching for a valid key that matches eviction key 114. As discussed, each eviction compare circuit 404 is capable of comparing eviction key 114 with contents of a corresponding memory location and outputting a search result 410. The search results 410 collectively form bit vector 502 which is provided to priority encoder 430.

Priority encoder outputs eviction match address 444 and eviction match valid 446 to insert-delete circuit 106. In the example, a valid state of eviction match valid 446 indicates that eviction match address 444 is valid, e.g., that a match to eviction key 112 was found. An invalid state of eviction match valid 446 indicates that eviction match address 444 is invalid and that the search did not find a key matching eviction key 114 in key memory circuit 104.

In block 706, in response to finding a match (e.g., eviction match valid 446 indicating a valid state), method 700 continues to block 710. In response to no match being found (e.g., eviction match valid 446 indicating an invalid state), method 700 continues to block 708.

In block 708, in the case where no match was found, no action need be taken. In block 710, a delete operation may be started. In block 710, in the case where a match was found, insert-delete circuit 106 sets the validity bit of the matched entry to indicate an invalid state. As discussed, the address of the matched entry as determined by a priority encoder of key memory circuit 104 is provided to insert-delete circuit 106. Insert-delete circuit 106 sets the validity bit in the memory location specified by the address to indicate that the content of the memory location is not valid. Consider an example where eviction compare circuit 404-2 detects that eviction key 114 matches key 2, which is a valid key. In that case, insert-delete circuit 106 receives the address in which key 2 is stored and sets the validity bit concatenated with key 2 to indicate that key 2 is invalid.

In block 712, insert-delete circuit 106 is capable of providing the matched address to memory manager circuit 108. In block 714, memory manager circuit 108 is capable of adding the address received from insert-delete circuit 106 to the list of free memory addresses. After either of blocks 708 or 714, method 700 may continue to iterate as further eviction keys are received.

The disclosed technology provides a self-managed on-chip KVS architecture. The distributed nature of the implementations described herein provides for each distributed value memory an ALU dedicated thereto to perform various preconfigured operations to support state data tracking. The data paths within the KVS architecture are pipelined and include data-forwarding logic to enable back-to-back operations such as search, insert, and update safely and without data loss.

The terminology used herein is for the purpose of describing particular implementations only and is not intended to be limiting. Notwithstanding, several definitions that apply throughout this document are expressly defined as follows.

As defined herein, the singular forms “a,” “an,” and “the” are intended to include the plural forms as well, unless the context clearly indicates otherwise.

As defined herein, the term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise.

As defined herein, the term “automatically” means without human intervention.

As defined herein, the term “computer-readable storage medium” means a storage medium that contains or stores program instructions for use by or in connection with an instruction execution system, apparatus, or device. As defined herein, a “computer-readable storage medium” is not a transitory, propagating signal per se. The various forms of memory, as described herein, are examples of a computer-readable storage medium or two or more computer-readable storage mediums. A non-exhaustive list of examples of a computer-readable storage medium may include an electronic storage device, a magnetic storage device, an optical storage device, an electromagnetic storage device, a semiconductor storage device, or any suitable combination of the foregoing. A non-exhaustive list of more specific examples of a computer-readable storage medium may include: a portable computer diskette, a hard disk, a RAM, a read-only memory (ROM), an erasable programmable read-only memory (EPROM or Flash memory), an electronically erasable programmable read-only memory (EEPROM), a static random-access memory (SRAM), a double-data rate synchronous dynamic RAM memory (DDR SDRAM or “DDR”), a portable compact disc read-only memory (CD-ROM), a digital versatile disk (DVD), a memory stick, a floppy disk, or the like.

As defined herein, the phrase “in response to” and the phrase “responsive to” means responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

As defined herein, the term “user” refers to a human being.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The descriptions of the various implementations of the disclosed technology have been presented for purposes of illustration, but are not intended to be exhaustive or limited to the examples disclosed. Many modifications and variations will be apparent to those of ordinary skill in the art without departing from the scope and spirit of the described implementations. The terminology used herein was chosen to best explain the principles of the disclosed technology, the practical application or technical improvement over technologies found in the marketplace, or to enable others of ordinary skill in the art to understand the implementations disclosed herein.

What is claimed is:

1. An electronic system, comprising:
a key memory circuit capable of storing a plurality of keys and outputting an address for a key of the plurality of keys matched to a search key;
a memory manager circuit capable of tracking free memory addresses in the key memory circuit;
a state tracker circuit including a value memory circuit, wherein the value memory circuit is capable of storing values of state information and is separate from the key memory circuit; and
an insert-delete circuit capable of passing the address from the key memory circuit to the state tracker circuit, performing insert and delete operations on the key memory circuit, and providing free memory addresses of the key memory circuit to the memory manager circuit.

2. The electronic system of claim 1, wherein the key memory circuit is implemented as a binary content addressable memory.

3. The electronic system of claim 1, wherein the state tracker circuit includes an arithmetic logic unit coupled to the value memory circuit.

4. The electronic system of claim 3, wherein the state tracker circuit is configured to perform a selected operation based on data output from the key memory circuit and store a result within the value memory circuit at the address indicated by the key memory circuit.

5. The electronic system of claim 1, wherein the state tracker circuit is one of a plurality of state tracker circuits, wherein each state tracker circuit includes a value memory circuit and an arithmetic logic unit, and wherein each arithmetic logic unit is configured to perform a particular state tracking operation.

6. The electronic system of claim 1, wherein the key memory circuit includes a pipelined search circuit structure comprising:
N memory locations each capable of storing a key;
N search compare circuits each capable of comparing the search key with content stored in a corresponding one of the N memory locations, wherein the N search compare circuits generate a bit vector specifying Boolean match flags; and
a priority encoder capable of outputting an address for the key that matches the search key based on the bit vector.

7. The electronic system of claim 1, wherein the insert-delete circuit is capable storing a key in a selected memory location of the key memory circuit that is free based on an address provided from the memory manager circuit.

8. The electronic system of claim 1, wherein the key memory circuit includes a pipelined eviction circuit structure comprising:
N memory locations each capable of storing a key;
N eviction compare circuits each capable of comparing an eviction key with content stored in a corresponding one of the N memory locations, wherein the N eviction compare circuits generate a bit vector specifying Boolean match flags; and
a priority encoder capable of outputting an address specifying a key that matches the eviction key based on the bit vector.

9. The electronic system of claim 8, wherein each memory location of the N memory locations includes a validity bit indicating whether content stored therein is a valid key.

10. The electronic system of claim 9, wherein the insert-delete circuit is capable of implementing a delete operation for a selected key stored in a selected memory location of the key memory circuit by setting the validity bit to indicate an invalid state.

11. The electronic system of claim 10, wherein the delete operation operates only on the key memory circuit.

12. The electronic system of claim 10, wherein the memory manager circuit is capable of adding an address of the selected memory location to a list of free memory addresses of memory locations in the key memory circuit.

13. The electronic system of claim 1, wherein the insert-delete circuit is capable of obtaining a selected free memory address from the memory manager circuit in response to a further search key not matching any keys stored in the key memory circuit and storing the further search key at a memory location of the key memory circuit specified by the selected free memory address.

14. A method, comprising:
storing a plurality of keys in a key memory circuit;
in response to receiving a search key, outputting, from the key memory circuit, an address for a key of the plurality of keys that matches the search key;
passing the address from the key memory circuit to a plurality of state tracker circuits, wherein each state tracker circuit includes a value memory circuit coupled to an arithmetic logic unit; and
in each state tracker circuit of the plurality of state tracker circuits, implementing a selected operation by the arithmetic logic unit that generates state information for the search key.

15. The method of claim 14, wherein the selected operation causes the arithmetic logic unit to perform at least one of reading a value stored in the value memory circuit coupled thereto from a location specified by the address or writing a value output from the arithmetic logic unit in the value memory circuit coupled thereto at the location specified by the address.

16. The method of claim 14, wherein the key memory circuit is implemented as a binary content addressable memory.

17. The method of claim 14, wherein the value memory circuit is distinct and independent of the key memory circuit.

18. The method of claim 14, further comprising generating the address by:
a plurality of search compare circuits comparing the search key with content stored in corresponding memory locations of a plurality of memory locations of the key memory circuit;
outputting, from the plurality of search compare circuits, a bit vector formed of a plurality of Boolean match flags indicating comparison results; and
encoding the bit vector into the address.

19. The method of claim 14, wherein the key memory circuit includes a plurality of memory locations each capable of storing a key and including a validity bit indicating whether content stored therein is a valid key.

20. The method of claim 19, further comprising:
implementing, by an insert-delete circuit, a delete operation for a selected key stored in a selected memory location of the plurality of memory locations by setting the validity bit of the memory location to invalid.
